(19) United States
(12) Patent Application Publication
(10) Pub. No.: US 2012/0159639 A1
(43) Pub. Date: Jun. 21, 2012

(54) METHOD OF PROVIDING CUSTOMIZED SERVICE WITH PRIVACY SECURITY

(75) Inventors: Jong Hyouk NOH, Daejeon (KR); Soo Hyung Kim, Daejeon (KR); Seung Hyun Kim, Daejeon (KR); Sang Rae Cho, Daejeon (KR); Young Seob Cho, Daejeon (KR); Dae Seon Choi, Daejeon (KR); Seung Hun Jin, Daejeon (KR)

(73) Assignee: Electronics and Telecommunications Research Institute, Daejeon (KR)

(21) Appl. No.: 13/291,292

(22) Filed: Nov. 8, 2011

(30) Foreign Application Priority Data
Dec. 15, 2010 (KR) 10-2010-0128715

(51) Int. Cl. G06F 21/24

(52) U.S. Cl. 726/26

(57) ABSTRACT

A method of providing customized service with privacy security includes: requesting service information provided from a smart environment to a smart environment control system; once the service information is transmitted from the smart environment control system, generating schedule information by using the service information, user personal information, and schedule generation information; and transmitting a service command to the smart environment control system according to the schedule information.

### CROSS-REFERENCE TO RELATED APPLICATIONS

The present application claims priority to Korean patent application number 10-2010-0128715, filed on Dec. 15, 2010, which is incorporated by reference in its entirety.

### BACKGROUND OF THE INVENTION

The present invention relates to an apparatus for providing service in a smart environment, and more particularly, to a method of providing customized service with privacy security without providing user's personal information in a smart environment.

In order to make human life more prosperous, researches on providing information and intelligence-oriented space where people lives are actively in progress. These series of techniques are called ubiquitous techniques. As typical examples, there are a smart home that makes people living in a house more comfortable and a smart office that provides efficient working space. These smart home and smart office are important subjects for smart environment researches.

The smart environment is purposefully directed to provide intelligent, interactive, and customized services to a user. In order to provide these services, information related to a user is required, so that a smart environmental system requires user's personal information.

A smart home may be a safe place even if home owner's information is provided but an office or a hotel with a smart environment, which is managed by others, may be a place where a user may be reluctant to share personal information. The reason is that personal information may be stored and then misused.

Accordingly, anonymity techniques are studied recently to prevent personal information from being provided in a smart environment.

The above technical configuration is just a background technique to help understanding the present invention and does not mean a conventional technique known to those skilled in the art.

### SUMMARY OF THE INVENTION

Embodiments of the present invention are directed to a method of providing customized service with privacy security, by transmitting service lists and control information from a smart environment control system to a mobile terminal and by using service lists and control information according to a pre-stored service usage history information in a mobile terminal.

In one embodiment, a method of providing customized service with privacy security includes: requesting service information provided from a smart environment to a smart environment control system; once the service information is transmitted from the smart environment control system, generating schedule information by using the service information, user personal information, and schedule generation information; and transmitting a service command to the smart environment control system according to the schedule information.

The schedule generation information may include: service history information that a user uses and generates in a previous smart environment; and environmental information comprising current time, temperature, humidity, position, and weather.

The service information may include: list information of services provided from the smart environment; and control information to use the services in the list information.

In another embodiment, a device of providing customized service with privacy security includes: a service information requesting unit configured to request and receive service information provided from a smart environment to and from a smart environment control system; a personal information storing unit configured to store personal information of a user; a schedule information generating unit, once the service information is received from the smart environment control system, configured to generate schedule information by using the service information, user personal information, and schedule generation information; and a service command transmitting unit configured to transmit a service control command to the smart environment control system according to the schedule information generated by the schedule information generating unit.

The schedule generation information storing unit may include: a service usage history information storing unit configured to store a service usage history that a user uses and generates in a previous smart environment; and an environmental information storing unit configured to store environmental information comprising current time, temperature, humidity, position, and weather.

The service information may include: list information of services provided from the smart environment; and control information to use the services in the list information.

### BRIEF DESCRIPTION OF THE DRAWINGS

FIG. 1 illustrates a flowchart of a customized service ensuring personal information protection in a smart environment.

FIG. 2 illustrates a block diagram of a customized service providing device ensuring personal information according to one embodiment of the present invention.

FIG. 3 illustrates a method of providing customized service with privacy security according to one embodiment of the present invention.

### DESCRIPTION OF SPECIFIC EMBODIMENTS

Hereinafter, a method of providing customized service with privacy security without providing user's personal information in a smart environment in accordance with the present invention will be described in detail with reference to the accompanying drawings. In the drawings, the thicknesses of layers and regions are exaggerated for clarity. While the present invention has been particularly shown and described with reference to exemplary embodiments thereof, it will be understood by those of ordinary skill in the art that various changes in form and details may be made therein without departing from the spirit and scope of the present invention as defined by the following claims.

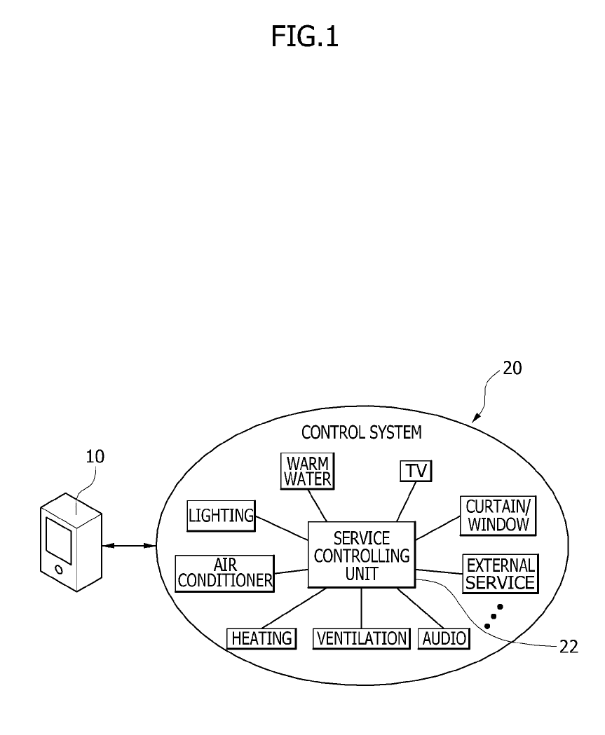

FIG. 1 illustrates a flowchart of a customized service ensuring personal information protection in a smart environment.

Referring to FIG. 1, for user convenience in a smart environment, various services are provided. These services include TV service, curtain/window service, outdoor service, audio service, and ventilation service.

Each service provided in a smart environment may directly use a mobile terminal 10.

User's personal information needs to be inputted to use various services through the mobile terminal 10 provided from a smart environment. In this case, user's personal information is exposed. Accordingly, the mobile terminal 10 may use various services provided from a smart environment without personal information exposure.

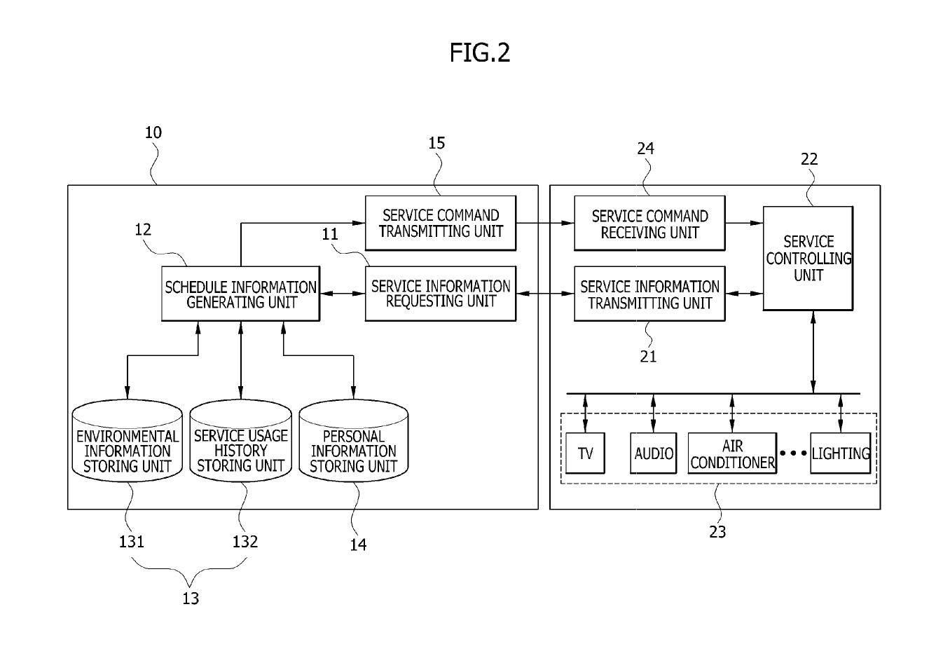

FIG. 2 illustrates a block diagram of a customized service providing device ensuring personal information according to one embodiment of the present invention.

The customized service providing device for ensuring personal information uses various services in a smart environment through the mobile terminal 10 without personal information exposure and includes the mobile terminal 10 and a smart environment controlling system 20.

The mobile terminal 10 requests service information provided in a smart environment, generates schedule information by using the received service information, user's personal information, and schedule generation information, and transmits a service command to the smart environment control system 20 according to schedule information.

Accordingly, based on the service command transmitted according to the schedule information, the smart environment control system 20 operates to provide a customized service to a user.

The service information includes service list information provided from a smart environment and control information for a service device 23 providing services in the service list information.

Here, the service list information lists services provided from a smart environment includes all services from a smart environment such as TV service, audio service, heating service, lighting service, and ventilation service.

A control method allows a user to use various services in the service list information and includes channel change, volume adjustment, and on/off of the TV service and a position, brightness, and on/off of the lighting service.

This control method is variously prepared for each service provided from a smart environment.

The schedule generation information is basic information for generating schedule information. The schedule generation information includes service usage history information that a user previously uses and generates in a smart environment and environmental information such as current time, temperature, humidity, position, and weather. Additionally, the schedule generation information includes private certification, airline ticket reservation, and meeting time and place.

The schedule information defines various services provided spatially and temporally to a user in a smart environment. Accordingly, the schedule information may be diversely generated according to behavior pattern, environment, and service usage history of a user. The smart environment control system 20 provides various services according to a service command transmitted from the mobile terminal 10 according to the schedule information, so that a customized service may be provided to a user.

The mobile terminal 10 includes service information requesting unit 11, a schedule information generating unit 12, a schedule generation information storing unit 13, a personal information storing unit 14, and a service command transmitting unit 15.

The service information requesting unit 11 requests service information to the smart environment control system 20, and receives service information transmitted from the smart environment control system 20 to input it to the schedule information generating unit 12.

The schedule generation information storing unit 13 includes an environmental information storing unit 131 and a service usage history storing unit 132.

The environmental information storing unit 131 includes various environmental information for a user's position such as current time, temperature, humidity, position information, and weather. This environmental information may be provided through various methods via a wire/wireless network.

The service usage history information storing unit 132 stores information for services that a user previously uses and generates in a smart environment. Information about services that a user frequently or periodically uses may be obtained through the information stored in the service usage history storing unit 132.

The personal information storing unit 14 stores users' personal information. The personal information includes a schedule, an address book, mails, identification (ID), credit card information of a user and additionally includes all personal information used in a smart environment such as airline ticket reservation, meeting time and place, favorite music, favorite movie, and user health information.

Once service information is inputted from the service information requesting unit 11, the schedule information generating unit 12 generates schedule information using the service information and personal information and schedule generating information of a user.

In the above manner, the schedule information is generated by service information available in a smart environment at a position that a user currently exists, personal information of a user's schedule, and schedule generation information such as services and environment that a user uses in a smart environment. Therefore, a customized service appropriate for a user may be provided.

The service command transmitting unit 15 transmits a service command to the smart environment control system 20 according to the schedule information generated by the schedule information generating unit 12.

The smart environment control system 20 includes a service information transmitting unit 21, a service controlling unit 22, a service command receiving unit 24, and a service device 23.

The service information transmitting unit 21 transmits service information inputted from the service controlling unit 22 to the service information requesting unit 11 according to requested service information received from the service information requesting unit 11.

The service command receiving unit 24 inputs a service command transmitted from the service command transmitting unit 15 to the service controlling unit 22.

The service device 23 includes various devices such as a TV, an audio, an air conditioner, and a lighting, as a device performing various services provided from a smart environment.

Once service information is requested from the service information transmitting unit 21, the service controlling unit 22 extracts the service information and inputs it to the service information transmitting unit 21.

Additionally, once a service command is received from the service command transmitting unit 15, the service device is controlled according to this service command to provide a service to a user.

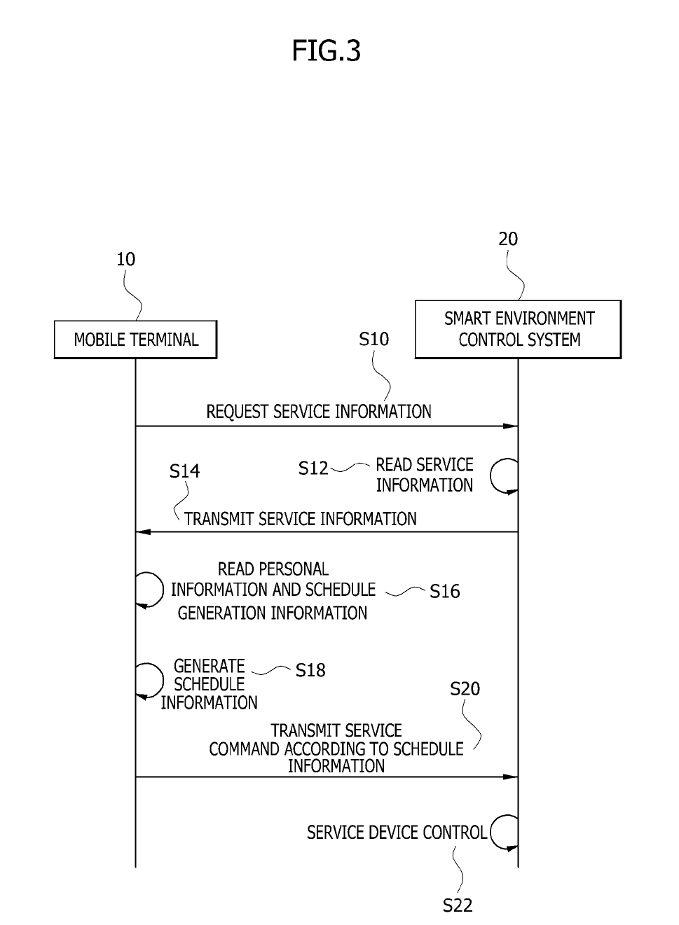

Hereinafter, a method of providing customized service with privacy security according to one embodiment of the present invention will be described with reference to FIG. 3.

FIG. 3 illustrates a method of providing customized service with privacy security according to one embodiment of the present invention.

First, the service information requesting unit 11 request service information to the service information transmitting unit 21 in operation S10.

Once the service controlling unit 22 receives the service information, it extracts the service information in operation S12 and transmits the extracted service information to the service information requesting unit 11 of the mobile terminal 10 through the service information transmitting unit 21 in operation S14.

The service information requesting unit 11 inputs the transmitted service information to the schedule information generating unit 12.

The schedule information generating unit 12 reads personal information of a user from the personal information storing unit 14 and reads schedule generation information from the schedule generation information storing unit 13. That is, environmental information is read from the environmental information storing unit 131 and service usage history information of a user is read from the service usage history information storing unit 132 in operation S16.

Next, the schedule information storing unit generates schedule information by using service information, personal information, and schedule generation information in operation S18.

Accordingly, the service command transmitting unit 15 interprets the schedule information generated in the schedule information storing unit and transmits a service command to the service command receiving unit 24 according to schedule information in operation S20.

Once a service command is inputted from the service command receiving unit 24, the service controlling unit 22 provides service to a user according to the schedule information by controlling the service device 23 according to the service command in operation S22.

As one example, a morning wake up service among the customized services uses user's personal information such as schedule information to predict a user's wake up time of the next day.

Distance and traffic are predicted using a current position and a position of a place with a schedule and a wake up time is determined by considering a morning preparing time of a user.

Moreover, when a user wakes up by considering a condition of a user and temperature and humidity of a current position, temperature and humidity appropriate for a user may be predicted.

Moreover, a lighting that becomes slowly brighter according to user preference may be used or user's favorite music may be played. Additionally, a wake up time may be changed using weather and traffic information when a user wakes up.

For reference, this embodiment includes periodically generating schedule information by requesting service information and arbitrarily changing personal information by using an additional interface, so that the generating of new schedule information may be included.

The present invention does not disclosure user's personal information to the external if customized information is provided from a smart environment to prevent the reckless exposure of personal information in a smart environment and also controls a smart environment control system using a mobile terminal.

While the present invention has been described with respect to the specific embodiments, it will be apparent to those skilled in the art that various changes and modifications may be made without departing from the spirit and scope of the invention as defined in the following claims.

What is claimed is:

1. A method of providing customized service with privacy security, the method comprising:
requesting service information provided from a smart environment to a smart environment control system;
once the service information is transmitted from the smart environment control system, generating schedule information by using the service information, user personal information, and schedule generation information; and
transmitting a service command to the smart environment control system according to the schedule information.

2. The method of claim 1, wherein the schedule generation information comprises:
service history information that a user uses and generates in a previous smart environment; and
environmental information comprising current time, temperature, humidity, position, and weather.

3. The method of claim 1, wherein the service information comprises:
list information of services provided from the smart environment; and
control information to use the services in the list information.

4. A device of providing customized service with privacy security, the device comprising:
a service information requesting unit configured to request and receive service information provided from a smart environment to and from a smart environment control system;
a personal information storing unit configured to store personal information of a user;
a schedule information generating unit, once the service information is received from the smart environment control system, configured to generate schedule information by using the service information, user personal information, and schedule generation information; and
a service command transmitting unit configured to transmit a service control command to the smart environment control system according to the schedule information generated by the schedule information generating unit.

5. The device of claim 4, wherein the schedule generation information storing unit comprises:
a service usage history information storing unit configured to store a service usage history that a user uses and generates in a previous smart environment; and
an environmental information storing unit configured to store environmental information comprising current time, temperature, humidity, position, and weather.

6. The device of claim 4, wherein the service information comprises:
list information of services provided from the smart environment; and
control information to use the services in the list information.
